(19) United States
(12) Patent Application Publication
(10) Pub. No.: US 2026/0181085 A1
(43) Pub. Date: Jun. 25, 2026

(54) AUTOMATIC DOCUMENT FEEDER HAVING UPPER SCAN MODULE

(71) Applicant: KINPO ELECTRONICS, INC., NEW TAIPEI CITY (TW)

(72) Inventors: Po-Chih CHANG, NEW TAIPEI CITY (TW); Yu-Ying YU, NEW TAIPEI CITY (TW)

(21) Appl. No.: 19/060,778

(22) Filed: Feb. 23, 2025

(30) Foreign Application Priority Data
Dec. 20, 2024 (CN) 202411891337.6

(51) Int. Cl. H04N 1/00

(52) U.S. Cl. CPC H04N 1/00612; H04N 1/00602; H04N 1/00615

(57) ABSTRACT

The automatic document feeder includes an upper scan module and a paper delivery path. The upper scan module includes a scanning unit and a scanning platform. The paper delivery path is configured below the upper scan module. The scanning platform is arranged between the scanning unit and the paper delivery path. The paper delivery path transports the paper through the scanning unit and flips it over. Since the paper delivery path is arranged below the upper scan module, the paper may pass through the scanning unit as soon as it begins to traverse a partial range of the paper delivery path, eliminating the need for the paper to traverse most of the paper delivery path before reaching the scanning unit. By configuring the components and designing the passage of the paper delivery path, the time taken for the paper to pass through the paper delivery path may be shortened.

### BACKGROUND OF THE DISCLOSURE

### Technical Field

The technical field relates to an automatic document feeder with a scan function, and particularly to an automatic document feeder having an upper scan module.

### Description of Related Art

Offices usually have automatic document feeders (ADF) with scanning capabilities. The automatic document feeder includes a paper delivery path and an image scanning unit. The image scanning unit of the related art is mainly located below the paper delivery path, which is used for reversing and delivering the paper to the image scanning unit. The image scanning unit is used to capture the image of the paper.

However, since the aforementioned imaging scanning modules are mostly arranged below the paper delivery path, the paper must first pass through most of the feed path before being scanned by the imaging scanning unit. This results in the scanning process being overly time-consuming. After the back of the paper is scanned, the front side of the paper is facing up; thus, the paper needs to be fed into the machine for a third time to flip the paper over, turning it to the condition of having the front facing down. As a result, the paper needs to enter and exit the machine three times, which makes double-sided scanning excessively time-consuming.

Therefore, when the automatic document feeder is combined with a flatbed scanning device, how to configure the components and adjust the design of the paper delivery path to shorten the time of passing through the paper delivery path is the subject of this application.

In view of the above drawbacks, the inventor proposes this disclosure based on his expert knowledge and elaborate researches in order to solve the problems of related art.

### SUMMARY OF THE DISCLOSURE

This disclosure is directed to an automatic document feeder having an upper scan module, in which the paper delivery path is arranged below the upper scan module, so that the paper may pass through the scanning unit as soon as it begins to traverse a partial range of the paper delivery path, eliminating the need for the paper to traverse most of the paper delivery path before reaching the scanning unit. By configuring the components and designing the passage of the paper delivery path, the time taken for the paper to pass through the paper delivery path may be shortened, thereby improving the working efficiency of the automatic document feeder.

One of the exemplary embodiments, an automatic document feeder for transporting a paper including an upper scan module, a paper tray assembly, and a paper delivery path. The upper scan module includes a scanning unit and a scanning platform. The paper tray assembly includes an input paper tray, a first output paper tray, and a second output paper tray. The paper delivery path is configured below the upper scan module, wherein the scanning platform is positioned between the scanning unit and the paper delivery path, and the paper delivery path including: a scanning passage configured below the scanning unit; a paper feeding passage having one end connected to the scanning passage and another end disposed to correspond to the input paper tray; a first paper output passage having one end disposed to correspond to the first output paper tray; a reversing passage having one end connected to the scanning passage, and another end connected to the first paper output passage; a returning passage having one end connected to an intersection of the first paper output passage and the reversing passage, and another end connected to an intersection of the scanning passage and the paper feeding passage; a second paper output passage having one end connected to an intersection of the scanning passage and the reversing passage, and another end disposed to correspond to the second output paper tray; a first switching guide mechanism arranged at an intersection of the scanning passage, the reversing passage, and the second paper output passage, the first switching guide mechanism being configured to guide the paper from the scanning passage to the reversing passage or from the scanning passage to the second paper output passage; and a second switching guide mechanism arranged at an intersection of the first paper output passage, the reversing passage, and the returning passage, the second switching guide mechanism being configured to guide the paper from the first paper output passage to the returning passage.

One of the exemplary embodiments, an automatic document feeder for transporting a paper, including an upper scan module, a paper tray assembly, and a paper delivery path. The upper scan module includes a scanning unit and a scanning platform. The paper tray assembly includes an input paper tray and an output paper tray. The paper delivery path is configured below the upper scan module, wherein the scanning platform is positioned between the scanning unit and the paper delivery path, and the paper delivery path including: a scanning passage configured below the scanning unit; a paper feeding passage having one end connected to the scanning passage, and another end disposed to correspond to the input paper tray; a paper output passage having one end disposed to correspond to the output paper tray; a reversing passage having one end connected to the scanning passage, and another end connected to the paper output passage; a returning passage having one end connected to an intersection of the reversing passage and the paper output passage, and another end connected to an intersection of the scanning passage and the paper feeding passage; a reversing mechanism disposed between the paper output passage and the output paper tray, the reversing mechanism being configured to flip the paper and feed the paper to the output paper tray; a first switching guide mechanism arranged at an intersection of the reversing passage, the returning passage and the paper output passage, the first switching guide mechanism being configured to guide the paper from the paper output passage to the returning passage; and a second switching guide mechanism, arranged at an intersection of the paper output passage, the output paper tray and the reversing mechanism, the second switching guide mechanism being configured to guide the paper from the paper output passage to the output paper tray or from the paper output passage to the reversing mechanism.

One of the exemplary embodiments, an automatic document feeder for transporting a paper, including an upper scan module, a paper tray assembly, and a paper delivery path. The paper delivery path is configured below the upper scan module, wherein the scanning platform is positioned between the scanning unit and the paper delivery path, and the paper delivery path including: a scanning passage configured below the scanning unit; a paper feeding passage having one end connected to the scanning passage, and another end disposed to correspond to the input paper tray; a paper output passage having one end disposed to correspond to the output paper tray; a reversing passage having one end connected to the scanning passage, and another end connected to the paper output passage; a returning passage having one end connected to an intersection of the reversing passage and the paper output passage, and another end connected to an intersection of the scanning passage and the paper feeding passage; a reversing mechanism disposed between the paper output passage and the output paper tray, the reversing mechanism being configured to flip the paper and feed the paper to the output paper tray; a first switching guide mechanism arranged at an intersection of the reversing passage, the returning passage and the paper output passage, the first switching guide mechanism being configured to guide the paper from the paper output passage to the returning passage; and a second switching guide mechanism arranged at an intersection of the paper output passage, the output paper tray and the reversing mechanism, the second switching guide mechanism being configured to guide the paper from the paper output passage to the output paper tray or from the paper output passage to the reversing mechanism.

One of the exemplary embodiments, an automatic document feeder for transporting a paper, including an upper scan module, a paper tray assembly, and a paper delivery path. The upper scan module includes a scanning unit and a scanning platform. The paper tray assembly includes an input paper tray and an output paper tray. The paper delivery path is configured below the upper scan module, wherein the scanning platform is positioned between the scanning unit and the paper delivery path, and the paper delivery path including: a scanning passage configured below the scanning unit; a paper feeding passage having one end connected to the scanning passage, and another disposed to correspond to the input paper tray; a paper output passage having one end disposed to correspond to the output paper tray; a reversing passage having one end connected to the scanning passage, and another end connected to the paper output passage; a returning passage having one end connected to an intersection of the reversing passage and the paper output passage, and another end connected to an intersection of the scanning passage and the paper feeding passage; a reversing mechanism arranged between the paper output passage and the output paper tray, the reversing mechanism being configured to flip the paper and feed it to the output paper tray; and a switching guide mechanism arranged at an intersection of the paper output passage, the output paper tray and the reversing mechanism, the switching guide mechanism being configured to guide the paper from the paper output passage to the output paper tray or from the paper output passage to the reversing mechanism.

One of the exemplary embodiments, an automatic document feeder for transporting a paper, including an upper scan module, a paper tray assembly, and a paper delivery path. The upper scan module includes a scanning unit and a scanning platform. The paper tray assembly includes an input paper tray, a first output paper tray, and a second output paper tray. The paper delivery path is configured below the upper scan module, wherein the scanning platform is positioned between the scanning unit and the paper delivery path, and the paper delivery path including: a scanning passage configured below the scanning unit; a paper feeding passage having one end connected to the scanning passage, and another end disposed to correspond to the input paper tray; a first paper output passage having one end disposed to correspond to the first output paper tray; a first reversing passage having one end connected to the scanning passage, and another end connected to the first paper output passage; a second reversing passage having one end connected to an intersection of the scanning passage and the paper feeding passage, and another end connected to the first paper output passage and the first reversing passage; a second paper output passage including a round-trip passage, a first diversion passage, and a second diversion passage, wherein the round-trip passage is disposed to correspond to the second output paper tray; the first diversion passage has one end connected to an intersection of the scanning passage and the first reversing passage and another end connected to the round-trip passage; the second diversion passage having one end connected to an intersection of the first reversing passage and the second reversing passage and another end connected to an intersection of the round-trip passage and the first diversion passage; a first switching guide mechanism arranged at an intersection of the scanning passage, the first reversing passage, and the first diversion passage, wherein the first switching guide mechanism is configured to guide the paper from the scanning passage to the first reversing passage or from the scanning passage to the first diversion passage; and a second switching guide mechanism arranged at an intersection of the first paper output passage, the first reversing passage, the second reversing passage and the second diversion passage, wherein the second switching guide mechanism is configured to guide the paper from the first reversing passage to the first paper output passage, or from the second diversion passage to the second reversing passage.

Based on the above, since the image scanning unit of the automatic document feeder of the related art is arranged below the paper delivery path, the paper needs to pass through most of the paper delivery path before passing through the image scanning unit when the automatic document feeder of the related art scans paper. This leads to the issue of the automatic paper feeder of the related art taking too much time to perform the scanning process. In comparison, the paper delivery path of the automatic document feeder of this disclosure is arranged below the upper scanning module, so that the paper may pass through the scanning unit as soon as it passes through a partial range of the paper delivery path. Through the configuration and the passage design, the time taken for the paper to pass through the paper delivery path is shortened. The automatic paper feeder of this disclosure has the advantages of fast paper transmission, reduced scanning time, and improved scanning efficiency.

Based on the above, the automatic document feeder of the related art must drive the paper in and out of the machine and flip it over three times before the double-sided scanned paper is placed in the output tray with the front side facing down. In comparison, the upper scanning module and the paper delivery path of this disclosure are configured to achieve double-sided scanning without the need to pass through the reversing passage twice, saving one step and time of entering the machine. Therefore, the automatic document feeder of this disclosure has the advantages of fast paper transmission, reduced double-sided scanning time, and improved double-sided scanning efficiency.

### BRIEF DESCRIPTION OF THE DRAWINGS

The features of the disclosure believed to be novel are set forth with particularity in the appended claims. The disclosure itself, however, may be best understood by reference to the following detailed description of the disclosure, which describes a number of exemplary embodiments of the disclosure, taken in conjunction with the accompanying drawings, in which:

FIG. 1 depicts an operating schematic view of a first embodiment of the automatic document feeder according to this disclosure.

FIG. 2 depicts another operating schematic view of a first embodiment of the automatic document feeder according to this disclosure.

FIG. 3 depicts still another operating schematic view of a first embodiment of the automatic document feeder according to this disclosure.

FIG. 4 depicts an operating schematic view of a second embodiment of the automatic document feeder according to this disclosure.

FIG. 5 depicts another operating schematic view of a second embodiment of the automatic document feeder according to this disclosure.

FIG. 6 depicts still another operating schematic view of a second embodiment of the automatic document feeder according to this disclosure.

FIG. 7 depicts an operating schematic view of a third embodiment of the automatic document feeder according to this disclosure.

FIG. 8 depicts another operating schematic view of a third embodiment of the automatic document feeder according to this disclosure.

FIG. 9 depicts still another operating schematic view of a third embodiment of the automatic document feeder according to this disclosure.

FIG. 10 depicts an operating schematic view of a fourth embodiment of the automatic document feeder according to this disclosure.

FIG. 11 depicts another operating schematic view of a fourth embodiment of the automatic document feeder according to this disclosure.

FIG. 12 depicts still another operating schematic view of a fourth embodiment of the automatic document feeder according to this disclosure.

FIG. 13 depicts an operating schematic view of a fifth embodiment of the automatic document feeder according to this disclosure.

FIG. 14 depicts another operating schematic view of a fifth embodiment of the automatic document feeder according to this disclosure.

FIG. 15 depicts still another operating schematic view of a fifth embodiment of the automatic document feeder according to this disclosure.

FIG. 16 depicts an operating schematic view of a sixth embodiment of the automatic document feeder according to this disclosure.

FIG. 17 depicts another operating schematic view of a sixth embodiment of the automatic document feeder according to this disclosure.

FIG. 18 depicts still another operating schematic view of a sixth embodiment of the automatic document feeder according to this disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

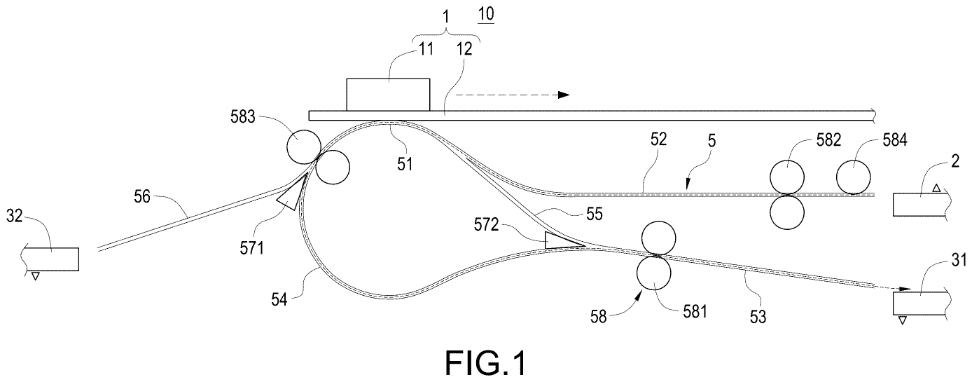

Referring to FIG. 1 to FIG. 3, this disclosure includes a first embodiment of an automatic document feeder having an upper scan module for delivering a paper (not shown in figures). The automatic document feeder 10 mainly includes an upper scan module 1, a paper tray assembly, and a paper delivery path 5.

Referring to FIG. 1 to FIG. 3, the upper scan module 1 includes a scanning unit 11 and a scanning platform 12. The paper tray assembly includes an input paper tray 2, a first output paper tray 31, and a second output paper tray 32. The entire paper delivery path 5 is configured below the upper scan module 1. The scanning platform 12 is arranged between the scanning unit 11 and the paper delivery path 5. The scanning unit 11 is an image capture device, such as a video camera or a camera, configured for capturing images. The scanning platform 12 is made of transparent glass to allow users to place papers for flatbed scanning.

The paper delivery path 5 includes a scanning passage 51, a paper feeding passage 52, a first paper output passage 53, a reversing passage 54, a returning passage 55, a second paper output passage 56, a first switching guide mechanism 571, and a second switching guide mechanism 572. The scanning passage 51 is configured under the scanning unit 11, wherein the scanning unit 11 is movable relative to the scanning platform 12 along the dashed arrow in the figure to capture images of the paper located on the scanning passage 51 or the scanning platform 12. The paper feeding passage 52 is positioned above the first output paper passage 53. The reversing passage 54 is a C-shaped passage configured to flip the paper as it passes through. Additionally, the scanning platform 12 of this embodiment is configured corresponding to the scanning passage 51 and the paper feeding passage 52, but this is not limited thereto.

Detailed description is as follows. The paper feeding passage 52 has one end connected to the scanning passage 51 and another end disposed corresponding to the input paper tray 2. The first paper output passage 53 has one end disposed corresponding to the first output paper tray 31. The reversing passage 54 has one end connected to the scanning passage 51 and another end connected to the first paper output passage 53. The returning passage 55 has one end connected to the intersection of the first paper output passage 53 and the reversing passage 54 and another end connected to the intersection of the scanning passage 51 and the paper feeding passage 52. The second paper output passage 56 has one end connected to the intersection of the scanning passage 51 and the reversing passage 54 and another end disposed corresponding to the second output paper tray 32.

Additionally, the first switching guide mechanism 571 is arranged at the intersection of the scanning passage 51, the reversing passage 54, and the second paper output passage 56. The first switching guide mechanism 571 includes a swinging block (first swinging block) driven by an actuator (not shown in figures) and may automatically swing to selectively close either the reversing passage 54 or the second paper output passage 56. Therefore, the first switching guide mechanism 571 is configured to guide the paper to be transported from the scanning passage 51 to the reversing passage 54 or to be transported from the scanning passage 51 to the second paper output passage 56.

Moreover, the second switching guide mechanism 572 is arranged at the intersection of the first paper output passage 53, the reversing passage 54, and the returning passage 55. The second switching guide mechanism 572 includes another swinging block (second swinging block) driven by an actuator (not shown in figures) and may automatically swing to selectively close or open the reversing passage 54. Therefore, the second switching guide mechanism 572 is configured to guide the paper to be transported from the first paper output passage 53 to the returning passage 55.

Additionally, the paper delivery path 5 further includes a feeding roller assembly 58. The feeding roller assembly 58 includes a bidirectional feeding roller 581 positioned on the first paper output passage 53, a first one-way paper feeding roller 582 and a pickup roller 584 respectively disposed on the paper feeding passage 52, and a second one-way paper feeding roller 583 installed on the scanning passage 51. The pickup roller 584 is configured to feed the paper from the input paper tray 2 to the paper feeding passage 52. The bidirectional feeding roller 581 is configured to feed paper in both clockwise and counterclockwise directions. The first one-way paper feeding roller 582 and the second one-way paper feeding roller 583 are configured to feed paper in either a clockwise or counterclockwise direction.

Please refer to FIG. 1, which depicts an operating schematic view showing a single-sided scanning of the first embodiment of the automatic document feeder 10. Firstly, the first switching guide mechanism 571 closes the second paper output passage 56, while the second switching guide mechanism 572 opens the reversing passage 54. This configuration allows the paper from the input paper tray 2 to face up, as indicated by the hollow arrow in the figure, and move along the dashed arrow sequentially through the paper feeding passage 52, the scanning passage 51, the reversing passage 54, and the first paper output passage 53 to the first output paper tray 31. The front side of the paper is scanned as it passes through the scanning passage 51. It is then flipped to face down through the reversing passage 54. Finally, the paper enters the first output paper tray 31 with the front side facing down, as indicated by the hollow arrow in the figure, completing the single-sided scanning process.

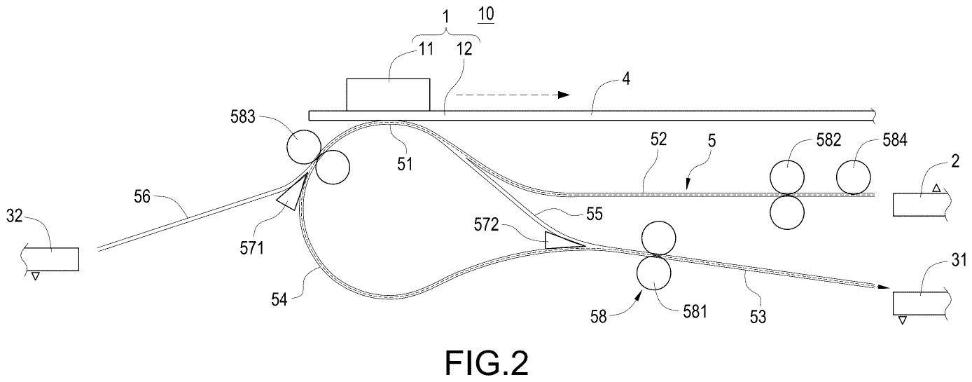

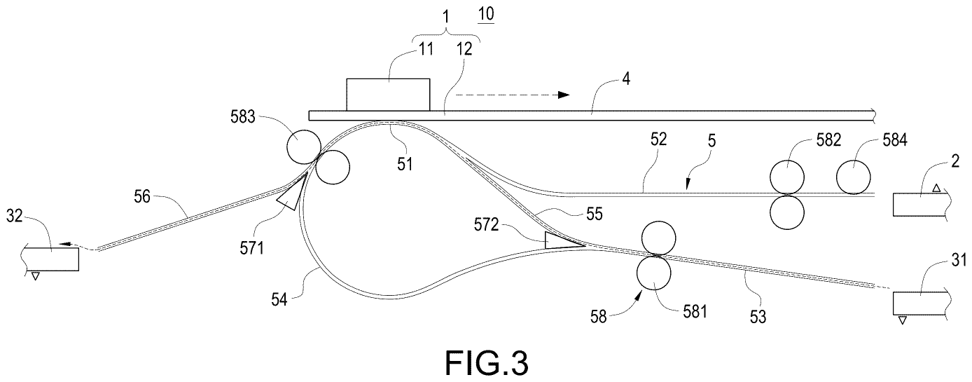

Please refer to FIG. 2 to FIG. 3, which depict operating schematic views showing a double-sided scanning of the first embodiment of the automatic document feeder 10. Firstly, as shown in FIG. 2, the first switching guide mechanism 571 closes the second paper output passage 56, and the second switching guide mechanism 572 opens the reversing passage 54. This configuration allows the paper from the input paper tray 2 to face up, as indicated by the hollow arrow in the figure, and move along the dashed arrow sequentially through the paper feeding passage 52, the scanning passage 51, and the reversing passage 54 to the first paper output passage 53. The front side of the paper is scanned as it passes through the scanning passage 51, performing the first scanning process. It is then flipped to face down through the reversing passage 54. As shown in FIG. 3, the first switching guide mechanism 571 and the second switching guide mechanism 572 close the reversing passage 54. The bidirectional paper feeding roller 581 rewinds the paper, so that the paper is facing down and moves along the dashed arrow sequentially through the first paper output passage 53, the returning passage 55, the scanning passage 51, and the second paper output passage 56 to the second output paper tray 32. Thus, the back side of the paper is scanned by the scanning unit 11 as it passes through the scanning passage 51 again, performing the second scanning process. Finally, the paper enters the second output paper tray 32 with the front side facing down, as indicated by the hollow arrow in the figure, completing the double-sided scanning process.

Since the image scanning unit of the automatic document feeder of the related art is arranged below the paper delivery path, the paper needs to pass through most of the paper delivery path before passing through the image scanning unit when the automatic document feeder of the related art scans paper. This leads to the issue of the automatic paper feeder of the related art taking too much time to perform the scanning process. In comparison, the paper delivery path 5 of the automatic document feeder 10 of this disclosure is arranged below the upper scanning module 1, so that the paper may pass through the scanning unit 11 as soon as it passes through a partial range of the paper delivery path 5. Then, through the configuration and the passage design of the first switching guide mechanism 571, the second switching guide mechanism 572, the first paper output passage 53, and the second paper output passage 56 of the paper delivery path 5, the time taken for the paper to pass through the paper delivery path 5 is shortened. The automatic paper feeder 10 of this disclosure has the advantages of fast paper transmission, reduced scanning time, and improved scanning efficiency.

Further, the automatic document feeder of the related art must drive the paper in and out of the machine and flip it over three times before the double-sided scanned paper is placed in the output tray with the front side facing down. In comparison, the upper scanning module 1 and the paper delivery path 5 of this disclosure are configured for double-sided scanning without the need to pass through the reversing passage 54 twice, saving one step and time of entering the machine. Therefore, the automatic document feeder 10 of this disclosure has the advantages of fast paper transmission, reduced double-sided scanning time, and improved double-sided scanning efficiency.

Moreover, the scanning platform 12 is provided for users to place the paper to perform a platform scanning, so that the scanning unit 11 captures the image of the paper located on the scanning passage 51 or the scanning platform 12. Therefore, the automatic document feeder 10 of this disclosure has the functions of automatic document feeding scanning and flatbed scanning. Thus, the automatic document feeding scanning and flatbed scanning functions utilize the same scanning unit 11 to achieve the characteristics of simplified components and cost savings for the automatic document feeder 10.

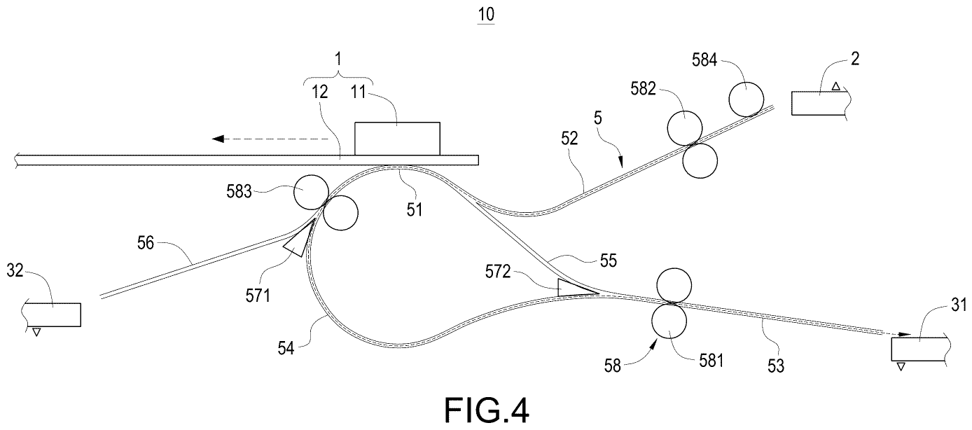

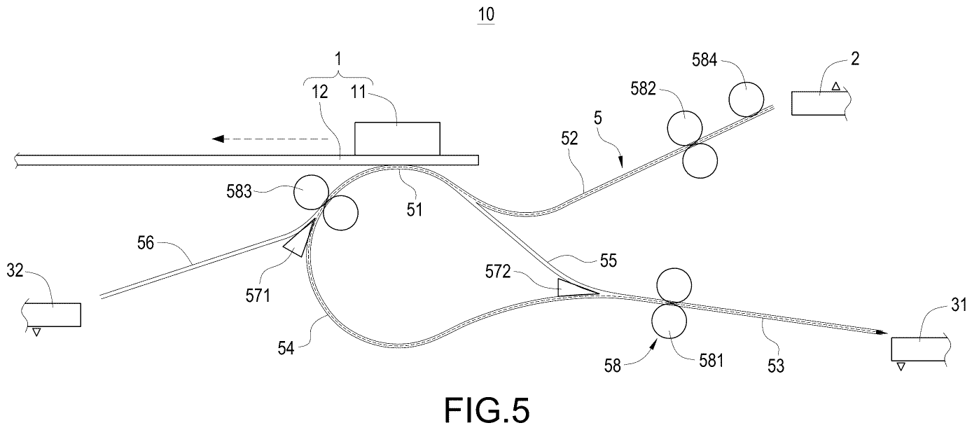

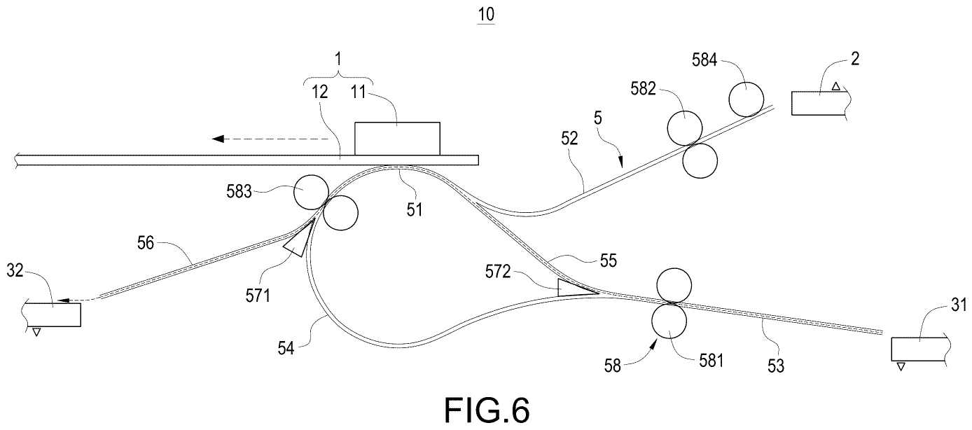

As shown in FIG. 4 to FIG. 6, which depict the second embodiment of the automatic document feeder 10, the second embodiment in FIG. 4 to FIG. 6 is substantially similar to the first embodiment in FIG. 1 to FIG. 3. The difference between the second embodiment in FIG. 4 to FIG. 6 and the first embodiment in FIG. 1 to FIG. 3 lies in the configuration of the scanning platform 12, which is disposed corresponding to the scanning passage 51 and the second paper output passage 56, and this is not limited thereto.

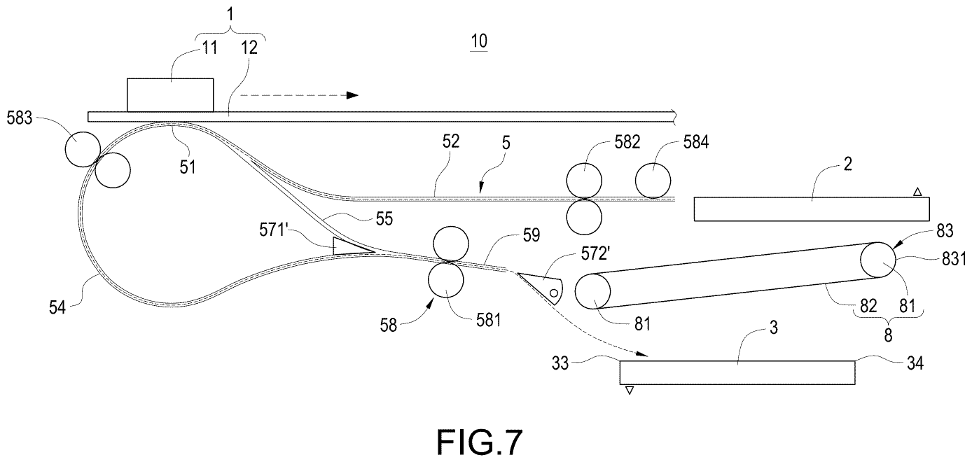

As shown in FIG. 7 to FIG. 9, which depict the third embodiment of the automatic document feeder 10, the third embodiment in FIG. 7 to FIG. 9 is substantially similar to the first embodiment in FIG. 1 to FIG. 3. The difference between the third embodiment in FIG. 7 to FIG. 9 and the first embodiment in FIG. 1 to FIG. 3 lies in the structures of the paper tray assembly and the paper delivery path 5.

Further description is as follows. The paper tray assembly of this disclosure includes an input paper tray 2 and an output paper tray 3. The paper output tray 3 has a first side 33 and a second side 34 opposite to each other. The paper delivery path 5 includes a scanning passage 51, a paper feeding passage 52, a paper output passage 59, a reversing passage 54, a returning passage 55, a reversing mechanism 8, a first switching guide mechanism 571′, and a second switching guide mechanism 572′. The reversing passage 54 is configured as a C-shaped passage. The paper feeding passage 52 is configured above the paper output passage 59.

The scanning passage 51 is configured below the scanning unit 11. The paper feeding passage 52 has one end connected to the scanning passage 51 and another end disposed corresponding to the input paper tray 2. The paper output passage 59 has one end disposed corresponding to the output paper tray 2. The reversing passage 54 has one end connected to the scanning passage 51 and another end connected to the paper output passage 59. The returning passage 55 has one end connected to the intersection of the reversing passage 54 and the paper output passage 59 and another end connected to an intersection of the scanning passage 51 and the paper feeding passage 52. The paper output passage 59 is located adjacent to the first side 33 of the output paper tray 3 and feeds the paper from the first side 33 towards the second side 34.

Furthermore, the reversing mechanism 8 is disposed between the paper output passage 59 and the output paper tray 3. The reversing mechanism 8 includes a paper feeding portion 83 located adjacent to the second side 34 of the paper output tray 3 and feeding the paper from the second side 34 towards the first side 33. The reversing mechanism 8 is configured to turn the paper over and feed it to the output paper tray 3.

Further description is as follows. The reversing mechanism 8 is disposed above the output paper tray 3. The reversing mechanism 8 includes one or a plurality of negative pressure rollers 81 and a breathable belt 82 fitted around (sheathing) the negative pressure rollers 81 and rotating with them. The paper feeding portion 83 is configured by an arc-shaped outer surface 831 and a breathable belt 82. The arc-shaped outer surface 831 is located adjacent to the second side 34 of the negative pressure roller 81 and rotatable along a direction from the second side 34 towards the first side 33, and the breathable belt 82 covers the outside of the arc-shaped outer surface 831. The negative pressure roller 81 provides negative pressure to the breathable belt 82 to make the paper flip over as it passes through the arc-shaped outer surface 831 and then be fed from the second side 34 towards the first side 33 into the output paper tray 3.

Moreover, the first switching guide mechanism 571′ is arranged at the intersection of the reversing passage 54, the returning passage 55, and the paper output passage 59. The first switching guide mechanism 571′ includes a swinging block (first swinging block) driven by an actuator (not shown in figures) and may automatically swing to selectively close or open the reversing passage 54. Therefore, the first switching guide mechanism 571 is configured to guide the paper to be transported from the paper output passage 59 to the returning passage 55.

Additionally, the second switching guide mechanism 572′ is arranged at the intersection of the paper output passage 59, the output paper tray 3, and the reversing mechanism 8. The second switching guide mechanism 572′ includes another swinging block (second swinging block) driven by an actuator (not shown in figures) and may automatically swing to selectively block the portion between the paper output passage 59 and the reversing mechanism 8, or block another portion between the paper output passage 59 and the output paper tray 3. Therefore, the second switching guide mechanism 572′ is configured to guide the paper to be transported from the paper output passage 59 to the output paper tray 3 or from the paper output passage 59 to the reversing mechanism 8.

Furthermore, the paper delivery path 5 further includes a feeding roller assembly 58. The feeding roller assembly 58 includes a bidirectional feeding roller 581 installed on the first paper output passage 59, a first one-way paper feeding roller 582 and a pickup roller 584 respectively installed on the paper feeding passage 52, and a second one-way paper feeding roller 583 installed on the scanning passage 51 or the reversing passage 54.

As shown in FIG. 7, which depicts an operating schematic view showing a single-sided scanning of the third embodiment of the automatic document feeder 10. Firstly, the second switching guide mechanism 572′ blocks the path between the paper output passage 59 and the reversing mechanism 8. The first switching guide mechanism 571′ opens the reversing passage 54. This configuration allows the paper from the input paper tray 2 to face up, as indicated by the hollow arrow in the figure, and move along the dashed arrow sequentially through the paper feeding passage 52, the scanning passage 51, the reversing passage 54, and the paper output passage 59 to the output paper tray 3. The front side of paper is scanned by the scanning unit 11 as it passes through the scanning passage 51. It is then flipped to face down through the reversing passage 54. Finally, the paper enters the output paper tray 3 with the front side facing down, as indicated by the hollow arrow in the figure, completing the single-sided scanning process.

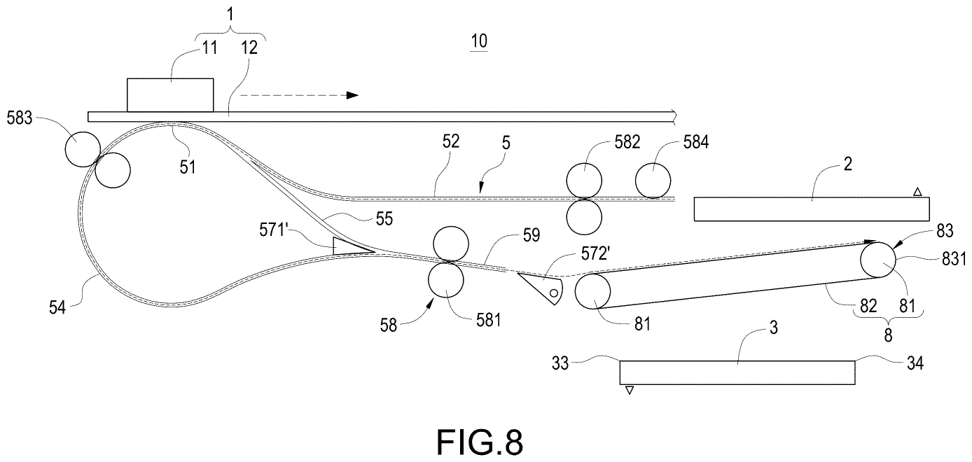

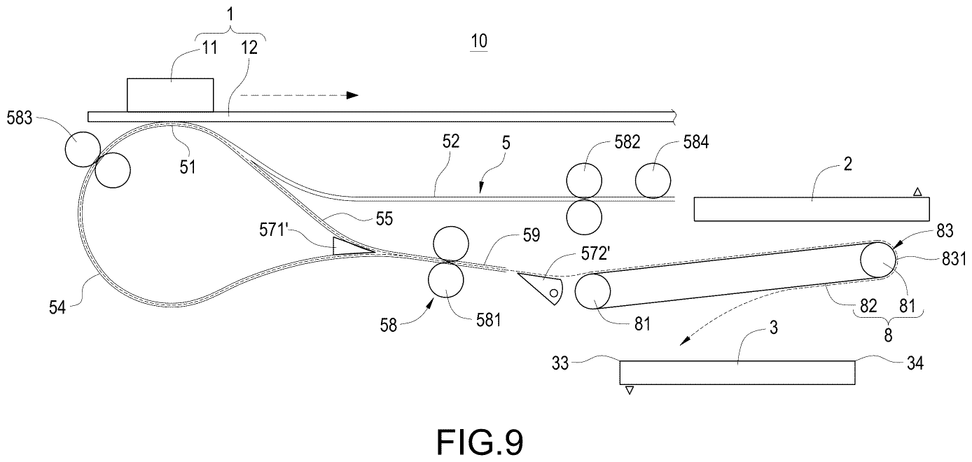

Please refer to FIG. 8 to FIG. 9, which depict operating schematic views showing a double-sided scanning of the third embodiment of the automatic document feeder 10. Firstly, as shown in FIG. 8, the second switching guide mechanism 572′ block the portion between the paper output passage 59 and the reversing mechanism 8. The first switching guide mechanism 571′ opens the reversing passage 54. This configuration allows the paper from the input paper tray 2 to face up, as indicated by the hollow arrow in the figure, and move along the dashed arrow sequentially through the paper feeding passage 52, the scanning passage 51, the reversing passage 54, and the paper output passage 59 to the reversing mechanism 8. The front side of the paper is scanned as it passes through the scanning passage 51, performing a first scanning process. It is then flipped to face down through the reversing passage 54. As shown in FIG. 9, the first switching guide mechanism 571′ closes the reversing passage 54. The bidirectional paper feeding roller 581 rewinds the paper to let it enter the paper output passage 59, and the returning passage 55. After that, the second switching guide mechanism 572′ blocks the path between the paper output passage 59 and the paper output tray 3, so that the paper is facing down and moves along the dashed arrow sequentially through the paper output passage 59, the returning passage 55, the scanning passage 51, the reversing passage 54, the paper output passage 59, the reversing mechanism 8 to the output paper tray 3. Thus, the back side of the paper is scanned by the scanning unit 11 as it passes through the scanning passage 51 again, performing the second scanning process. Then, the paper is flipped to face up through the reversing passage 54 and is flipped to face down through the reversing mechanism 8. Finally, the paper enters the second output paper tray 32 with the front side facing down, as indicated by the hollow arrow in the figure, to complete the double-sided scanning process.

The paper delivery path 5 of the automatic document feeder 10 in this disclosure is arranged below the scanning unit 11, so that the paper may pass through the scanning unit 11 as soon as it passes through the partial range of the paper delivery path 5. Then, through the configuration and the passage design of the first switching guide mechanism 571′, the second switching guide mechanism 572′, and the reversing mechanism 8 of the paper delivery path 5, the time taken for the paper to pass through the paper delivery path 5 is shortened. Thus, the same effects as those of the first embodiment shown in FIG. 1 to FIG. 3 may be achieved.

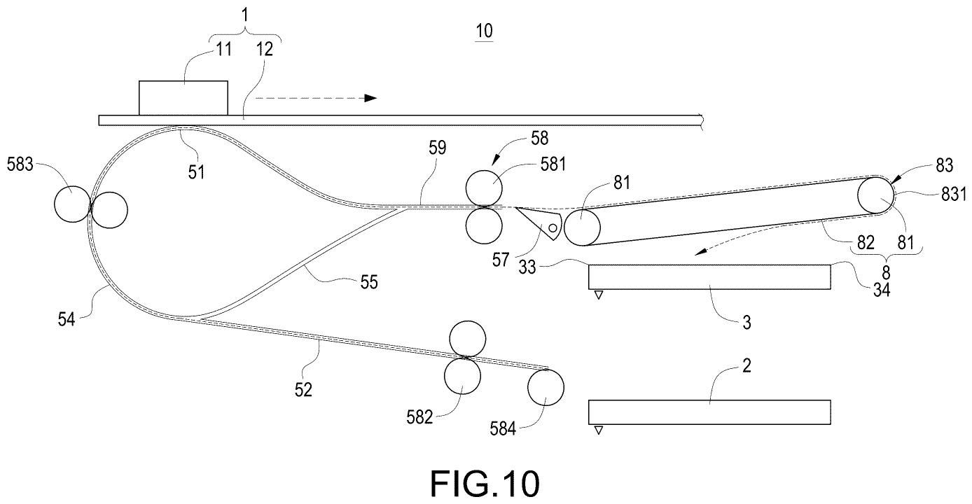

As shown in FIG. 10 to FIG. 12, which depict the fourth embodiment of the automatic document feeder 10 in this disclosure, the fourth embodiment in FIG. 10 to FIG. 12 is substantially similar to the third embodiment in FIG. 7 to FIG. 9. The difference between the fourth embodiment in FIG. 10 to FIG. 12 and the third embodiment in FIG. 7 to FIG. 9 lies in the paper feeding passage 52, which is arranged below the paper output passage 59, and the structure of the paper delivery path 5.

Further description is as follows. The paper delivery path 5 includes a scanning passage 51, a paper feeding passage 52, a paper output passage 59, a reversing passage 54, a returning passage 55, a reversing mechanism 8, and a first switching guide mechanism 57.

The switching guide mechanism 57 is arranged at the intersection of the paper output passage 59, the output paper tray 3, and the reversing mechanism 8. The switching guide mechanism 57 includes a swinging block driven by an actuator (not shown in figures) and may automatically swing to selectively block the portion between the paper output passage 59 and the reversing mechanism 8. Therefore, the first switching guide mechanism 57 is configured to guide the paper to be transported from the paper output passage 59 to the output paper tray 3 or from the paper output passage 59 to the reversing mechanism 8.

As shown in FIG. 10, which depicts an operating schematic view showing a single-sided scanning of the third embodiment of the automatic document feeder. Firstly, the switching guide mechanism 57 blocks the path between the paper output passage 59 and the output paper tray 3. This configuration allows the paper from the input paper tray 2 to face down, as indicated by the hollow arrow in the figure, and move along the dashed arrow sequentially through the paper feeding passage 52, the reversing passage 54, the scanning passage 51, the paper output passage 59, and the reversing mechanism 8 to the output paper tray 3. The paper is flipped to face up through the reversing passage 54, and the front side of the paper is scanned by the scanning unit 11 as it passes through the scanning passage 51, and then is flipped to face down through the reversing mechanism 8. Finally, the paper enters the output paper tray 3 with the front side facing down, as indicated by the hollow arrow in the figure, completing the single-sided scanning process.

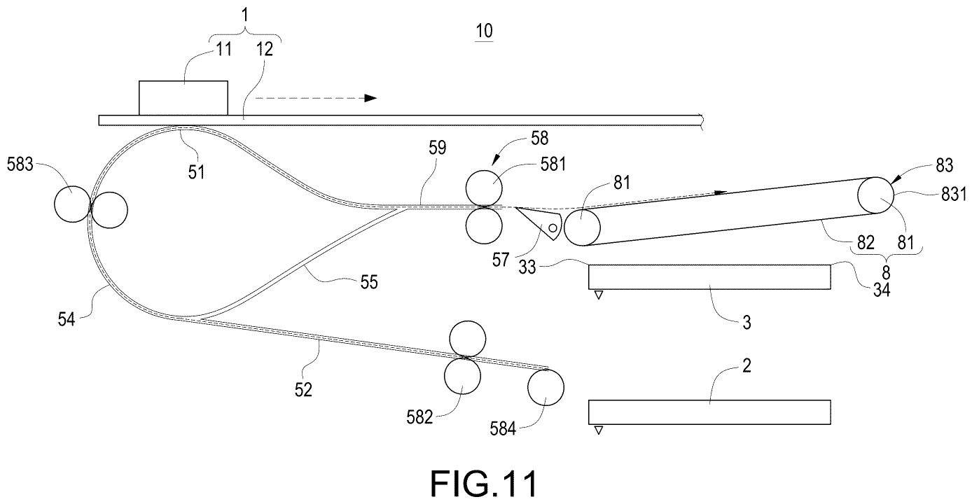

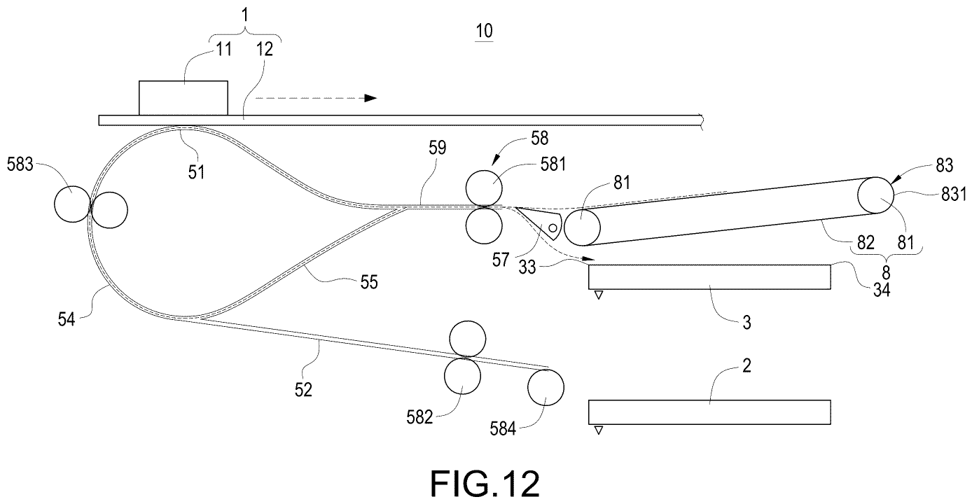

Please refer to FIG. 11 to FIG. 12, which depict operating schematic views showing a double-sided scanning of the third embodiment of the automatic document feeder 10. Firstly, as shown in FIG. 11, the switching guide mechanism 57 blocks the path between the paper output passage 59 and the reversing mechanism 8. This configuration allows the paper from the input paper tray 2 to face down, as indicated by the hollow arrow in the figure, and move along the dashed arrow sequentially through the paper feeding passage 52, the reversing passage 54, and the operating process 51 to the paper output passage 59 and the reversing mechanism 8. The paper is flipped to face up through the reversing passage 54, and the front side of the paper is scanned by the scanning unit 11 as it passes through the scanning passage 51, performing a first scanning process. Then, as shown in FIG. 12, the bidirectional paper feeding roller 581 rewinds the paper to let it enter the paper output passage 59 and the returning passage 55. After that, the switching guide mechanism 57 blocks the path between the paper output passage 59 and the paper output tray 3 again. Since the returning passage 55 is arranged below the scanning passage 51, and the paper on the paper output passage 59 is fed to the returning passage 55 by gravity, so that the paper moves along the dashed arrow sequentially through the paper output passage 59, the returning passage 55, the reversing passage 54, the scanning passage 51, and the paper output passage 59 to the output paper tray 3. The paper is flipped to face down through the reversing passage 54, and the back side of the paper is scanned by the scanning unit 11 as it passes through the scanning passage 51 again, performing the second scanning process. Finally, the paper enters the output paper tray 3 with the front side facing down, as indicated by the hollow arrow in the figure, completing the double-sided scanning process.

The paper delivery path 5 of the automatic document feeder 10 in this disclosure is arranged below the upper scan module 1, so that the paper passes through the scanning unit 11 as soon as it passes through a partial range of the paper delivery path 5. Then, through the configuration and the passage design of the switching guide mechanism 57 and the reversing mechanism 8, the time taken for the paper to pass through the paper delivery path 5 is shortened. Thus, the same effects as those of the first embodiment shown in FIG. 7 to FIG. 9 may be achieved

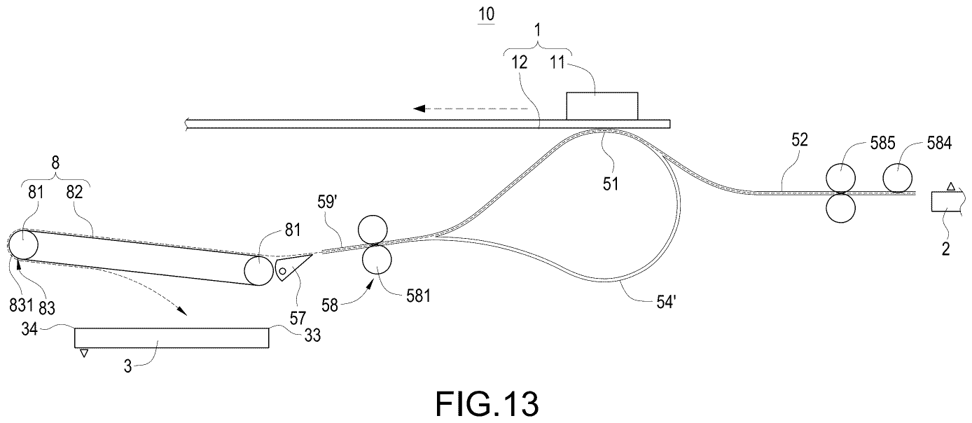

As shown in FIG. 13 to FIG. 15, which depict the fifth embodiment of the automatic document feeder 10, the fifth embodiment of FIG. 13 to FIG. 15 is substantially similar to the third embodiment in FIG. 7 to FIG. 9. The difference between the fifth embodiment shown in FIG. 13 to FIG. 15 and the third embodiment shown in FIG. 7 to FIG. 9 lies in the structure of the paper delivery path 5.

Further description is as follows. The paper delivery path 5 includes a scanning passage 51, a paper feeding passage 52, a paper output passage 59′, a reversing passage 54′, a reversing passage 54′, a reversing mechanism 8, and a switching guide mechanism 57.

The scanning passage 51 is configured below the upper scan module 1. The paper feeding passage 52 has one end connected to the scanning passage 51 and another end disposed corresponding to the input paper tray 2. The paper output passage 59′ has one end disposed corresponding to the scanning passage 51 and another end disposed corresponding to the output paper tray 3. The reversing passage 54′ is configured as a C-shaped passage. The reversing passage 54′ has one end connected to the intersection of the scanning passage 51 and the paper feeding passage 52 and another end connected to the intersection of the scanning passage 51 and the paper output passage 59′. The paper output passage 59′ is located adjacent to the first side 33 of the output paper tray 3 and feeds the paper from the first side 33 towards the second side 34, and the scanning platform 12 of this embodiment is disposed corresponding to the scanning passage 51 and the paper output passage 59′.

Furthermore, the reversing mechanism 8 is disposed between the paper output passage 59′ and the output paper tray 3. The reversing mechanism 8 is configured to turn the paper over and feed it to the output paper tray 3. The reversing mechanism 8 includes a paper feeding portion 83 located adjacent to the second side 34 of the paper output tray 3, feeding the paper from the second side 34 towards the first side 33. Thus, the reversing mechanism 8 turns the paper over and feeds it to the output paper tray 3.

Moreover, the switching guide mechanism 57 is arranged at the intersection of the paper output passage 59′, the output paper tray 3, and the reversing mechanism 8. The switching guide mechanism 57 includes a swinging block driven by an actuator (not shown in figures) and may automatically swing to selectively block the portion between the paper output passage 59′ and the reversing mechanism 8, or block another portion between the paper output passage 59′ and the output paper tray 3. Therefore, the switching guide mechanism 57 is configured to guide the paper to be transported from the paper output passage 59′ to the output paper tray 3 or from the paper output passage 59′ to the reversing mechanism 8.

Furthermore, the paper delivery path 5 further includes a feeding roller assembly 58. The feeding roller assembly 58 includes a bidirectional feeding roller 581 installed on the paper output passage 59′, a one-way paper feeding roller 585 and a pickup roller 584 respectively installed on the paper feeding passage 52. The one-way paper feeding roller 585 feeds paper in either a clockwise or counterclockwise direction.

As shown in FIG. 13, which depicts an operating schematic view showing a single-sided scanning of the fifth embodiment of the automatic document feeder 10. Firstly, the switching guide mechanism 57 blocks the path between the paper output passage 59′ and the output paper tray 3. This configuration allows the paper from the input paper tray 2 to face up, as indicated by the hollow arrow in the figure, and move along the dashed arrow sequentially through the paper feeding passage 52, the scanning passage 51, the paper output passage 59′, and the reversing mechanism 8 to the output paper tray 3. The front side of the paper is scanned by the scanning unit 11 as it passes through the scanning passage 51, performing a first scanning process, and then the paper is flipped to face down. At last, the paper enters the output paper tray 3 with the front side facing down, as indicated by the hollow arrow in the figure, completing the single-sided scanning process.

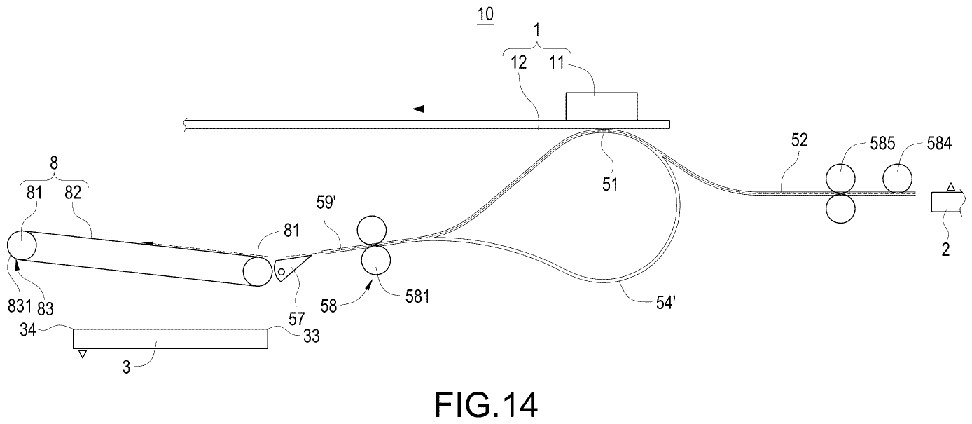

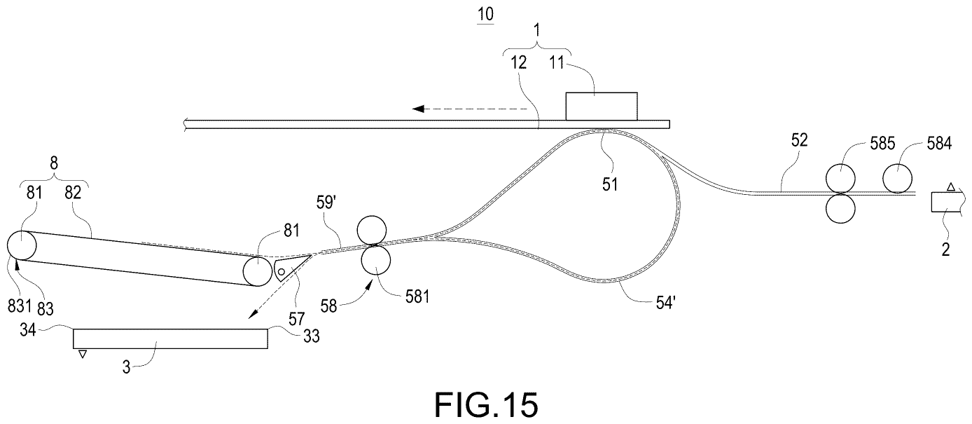

Please refer to FIG. 14 to FIG. 15, which depict operating schematic views showing a double-sided scanning of the fifth embodiment of the automatic document feeder 10. Firstly, as shown in FIG. 14, the switching guide mechanism 57 blocks the path between the paper output passage 59′ and the output paper tray 3. This configuration allows the paper from the input paper tray 2 to face up, as indicated by the hollow arrow in the figure, and move along the dashed arrow sequentially through the paper feeding passage 52 and the scanning passage 51 to the paper output passage 59′ and the reversing mechanism 8. The front side of the paper is scanned by the scanning unit 11 as it passes through the operating process 51, performing a first scanning process. Then, as shown in FIG. 15, the bidirectional paper feeding roller 581 rewinds the paper to let the it enter the paper output passage 59′. After that, the switching guide mechanism 57 block the portion between the paper output passage 59′ and the reversing mechanism 8 again. Since the reversing passage 54′ is arranged below the scanning passage 51, the paper on the paper output passage 59′ is fed to the reversing passage 54′ by gravity, so that the paper is face up and move along the dashed arrow sequentially through the paper output passage 59′, the reversing passage 54′, the scanning passage 51, and the paper output passage 59′ to the output paper tray 3. The paper is flipped to face down through the reversing passage 54′, and the back side of the paper is scanned by the scanning unit 11 as it passes through the scanning passage 51 again, performing the second scanning process. Finally, the paper enters the second output paper tray 32 with the front side facing down, as indicated by the hollow arrow in the figure, completing the double-sided scanning process.

Therefore, the paper delivery path 5 of the automatic document feeder 10 in this disclosure is arranged below the upper scan module 1, so that the paper may pass through the scanning unit 11 as soon as it passes through a partial range of the paper delivery path 5. Then, through the configuration and the passage design of the switching guide mechanism 57 and the reversing mechanism 8 of the paper delivery path 5, the time taken for the paper to pass through the paper delivery path 5 is shortened, and the same effects as those of the first embodiment shown in FIG. 7 to FIG. 9 may be achieved.

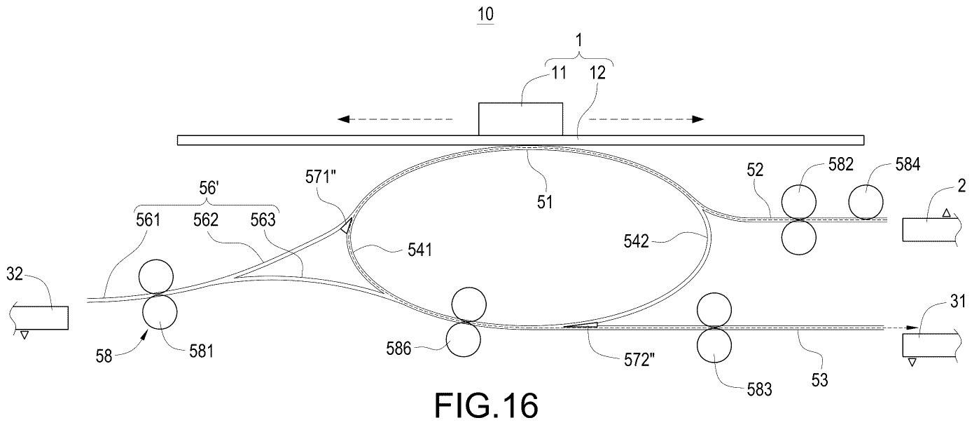

As shown in FIG. 16 to FIG. 18, which depict the sixth embodiment of the automatic document feeder 10. The sixth embodiment in FIG. 16 to FIG. 18 is substantially similar to the first embodiment in FIG. 1 to FIG. 3. The difference between the sixth embodiment shown in FIG. 16 to FIG. 18 and the first embodiment shown in FIG. 1 to FIG. 3 lies in the structure of the paper delivery path 5.

Further description is as follows. The paper delivery path 5 includes a scanning passage 51, a paper feeding passage 52, a first paper output passage 53, a first reversing passage 541, a second reversing passage 542, a second paper output passage 56′, a first switching guide mechanism 571″, and a second switching guide mechanism 572″.

The scanning passage 51 is configured below the upper scan module 1. The paper feeding passage 52 has one end connected to the scanning passage 51 and another end disposed corresponding to the input paper tray 2. The first paper output passage 53 has one end disposed corresponding to the first output paper tray 31. The first reversing passage 541 has one end connected to the scanning passage 51 and another end connected to the first paper output passage 53. The second reversing passage 542 has one end connected to the intersection of the scanning passage 51 and the paper feeding passage 52 and another end connected to the intersection of the first paper output passage 53 and the first reversing passage 541. The first reversing passage 541 and the second reversing passage 542 are respectively configured as C-shaped passages. An annular passage is configured by the scanning passage 51, the first reversing passage 541, and the second reversing passage 542 together. The scanning platform 12 of this embodiment is configured corresponding to the scanning passage 51, the paper feeding passage 52, the round-trip passage 561, and the first diversion passage 562.

Additionally, the second paper output passage 56′ includes a round-trip passage 561, a first diversion passage 562, and a second diversion passage 563. The round-trip passage 561 is disposed corresponding to the second output paper tray 32. The first diversion passage 561 has one end connected to the intersection of the scanning passage 51 and the first reversing passage 541 and another end connected to the round-trip passage 561. The second diversion passage 563 has one end connected to the intersection of the first reversing passage 541 and the second reversing passage 542 and another end connected to the intersection of the round-trip passage 561 and the first diversion passage 562.

Moreover, the first switching guide mechanism 571″ is arranged at the intersection of the scanning passage 51, the first reversing passage 541 and the first diversion passage 562. The first switching guide mechanism 571″ includes a swinging block (first swinging block) driven by an actuator (not shown in figures) and may automatically swing to selectively close the first reversing passage 541 or the first diversion passage 562. The first switching guide mechanism 571″ is configured to guide the paper to be transported from the scanning passage to the first reversing passage or from the scanning passage 51 to the first diversion passage 562.

Furthermore, the second switching guide mechanism 572″ is arranged at the intersection of the first paper output passage 53, the first reversing passage 541, the second reversing passage 542 and the second diversion passage 563. The second switching guide mechanism 572″ includes another swinging block (second swinging block) driven by an actuator (not shown in figures) and may automatically swing to selectively close the first paper output passage 53 or the second reversing passage 542. Therefore, the second switching guide mechanism 572″ is configured to guide the paper to be transported from the first reversing passage 541 to the first paper output passage 53 or to be transported from the second diversion passage 563 to the second reversing passage 542.

Additionally, the paper delivery path 5 further includes a feeding roller assembly 58. The feeding roller assembly 58 includes a bidirectional feeding roller 581 installed on the round-trip passage 561, a first one-way paper feeding roller 582 and a pickup roller 584 respectively installed on the paper feeding passage 52, a second one-way paper feeding roller 583 installed on the first paper output passage 53, and a third one-way paper feeding roller 586 installed on the first reversing passage 541 and adjacent to the first paper output passage 53. The third one-way paper feeding roller 586 feeds paper in either a clockwise or counterclockwise direction.

As shown in FIG. 16, which depicts an operating schematic view showing a single-sided scanning of the sixth embodiment of the automatic document feeder 10. Firstly, the first switching guide mechanism 571″ closes the first diversion passage 562, while the second switching guide mechanism 572″ closes the second reversing passage 542. This configuration allows the paper from the input paper tray 2 to face up, as indicated by the hollow arrow in the figure, and move along the dashed arrow sequentially through the paper feeding passage 52, the scanning passage 51, the first reversing passage 541, and the first paper output passage 53 to the first output paper tray 31. The front side is scanned by the scanning unit 11 as the paper passes through the scanning passage 51, and then it is flipped to face down through the first reversing passage 541.

Finally, the paper enters the first output paper tray 31 with the front side facing down, as indicated by the hollow arrow in the figure, completing the single-sided scanning of the paper.

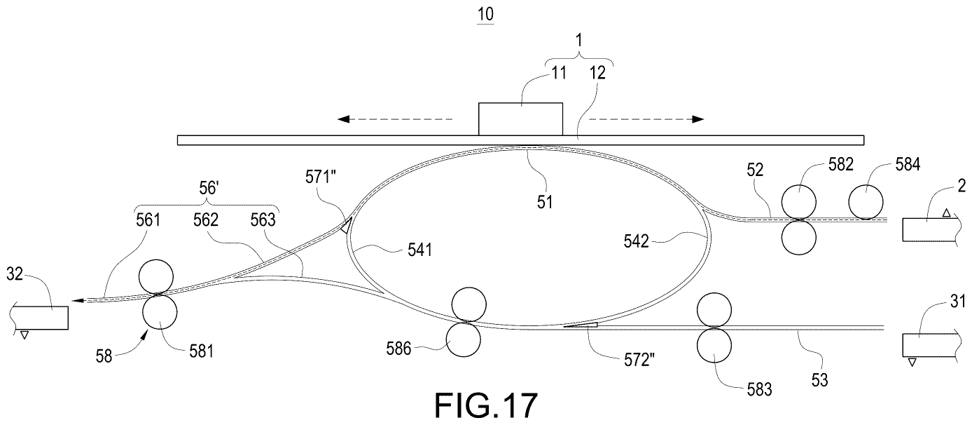

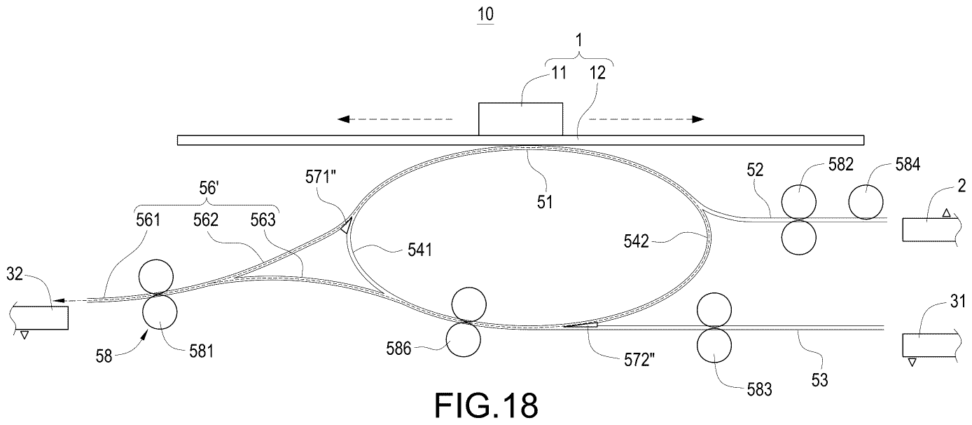

Please refer to FIG. 17 to FIG. 18, which depict operating schematic views showing a double-sided scanning of the sixth embodiment of the automatic document feeder 10. Firstly, as shown in FIG. 17, the first switching guide mechanism 571″ close the first reversing passage. This configuration allows the paper from the input paper tray 2 to face up, as indicated by the hollow arrow in the figure, and move along the dashed arrow sequentially through the paper feeding passage 52, the scanning passage 51, and the first diversion passage 562 to the round-trip passage 561. The front side of the paper is scanned as it passes through the operating process 51, performing a first scanning process. Then, as shown in FIG. 18, the second switching guide mechanism 572″ closes the first paper output passage 53, while the first switching guide mechanism 571″ closes the first reversing passage 541. The bidirectional paper feeding roller 581 rewinds the paper. Since the second diversion passage 563 is arranged below the first diversion passage 562, the paper on the round-trip passage 561 is fed into the second diversion passage 563 by gravity, so that the paper is face up and moves along the dashed arrow sequentially through the round-trip passage 561, the second diversion passage 563, the second reversing passage 542, the scanning passage 51, the first diversion passage 562, and the round-trip passage 561 to the second output paper tray 32. The paper is flipped to face down through the second reversing passage 542, and the back side of the paper is scanned by the scanning unit 11 as it passes through the scanning passage 51 again, performing a second scanning process. Finally, the paper enters the second output paper tray 32 with the front side facing down, as indicated by the hollow arrow in the figure, completing the double-sided scanning process.

The paper delivery path 5 of the automatic document feeder 10 in this disclosure is arranged below the upper scan module 1, so that the paper may pass through the scanning unit 11 as soon as the paper passes through a partial range of the paper delivery path 5. Then, through the configuration and the passage design of the first paper output passage 53, the first reversing passage 541, the second reversing passage 542, the second paper output passage 56′, the first switching guide mechanism 571″, and the second switching guide mechanism 572″, the time taken for the paper to pass through the paper delivery path 5 is shortened. Thus, the same effects as those of the first embodiment shown in FIG. 1 to FIG. 3 may be achieved.

While this disclosure has been described by means of specific embodiments, numerous modifications and variations may be made thereto by those skilled in the art without departing from the scope and spirit of this disclosure set forth in the claims.

What is claimed is:

1. An automatic document feeder, used for transporting a paper, comprising:
an upper scan module, comprising a scanning unit and a scanning platform;
a paper tray assembly, comprising an input paper tray, a first output paper tray, and a second output paper tray; and
a paper delivery path, disposed below the upper scan module, the scanning platform being positioned between the scanning unit and the paper delivery path, and the paper delivery path comprising:
a scanning passage, disposed below the scanning unit;
a paper feeding passage, one end thereof connected to the scanning passage and another end thereof disposed corresponding to the input paper tray;
a first paper output passage, one end thereof disposed corresponding to the first output paper tray;
a reversing passage, one end thereof connected to the scanning passage, and another end thereof connected to the first paper output passage;
a returning passage, one end thereof connected to an intersection of the first paper output passage and the reversing passage, and another end thereof connected to an intersection of the scanning passage and the paper feeding passage;
a second paper output passage, one end thereof connected to an intersection of the scanning passage and the reversing passage, and another end thereof disposed corresponding to the second output paper tray;
a first switching guide mechanism, arranged at an intersection of the scanning passage, the reversing passage, and the second paper output passage, configured to guide the paper to be transported from the scanning passage to the reversing passage or to be transported from the scanning passage to the second paper output passage; and
a second switching guide mechanism, arranged at an intersection of the first paper output passage, the reversing passage, and the returning passage, configured to guide the paper to be transported from the first paper output passage to the returning passage.

2. The automatic document feeder according to claim 1, wherein the scanning unit is configured to move relative to the scanning platform and capture an image of the paper located on the scanning passage or on the scanning platform; the reversing passage is shaped as a C-shaped passage, and the paper feeding passage is arranged above the first paper output passage; the first switching guide mechanism comprises a first swinging block configured to selectively close the reversing passage or the second paper output passage; and the second switching guide mechanism comprises a second swinging block configured to selectively open or close the reversing passage.

3. The automatic document feeder according to claim 1, wherein the paper delivery path further comprises a feeding roller assembly, add the feeding roller assembly comprises a bidirectional feeding roller installed on the first paper output passage, a first one-way paper feeding roller and a pickup roller respectively installed on the paper feeding passage, and a second one-way paper feeding roller installed on the scanning passage.

4. An automatic document feeder, used for transporting a paper, comprising:
an upper scan module, comprising a scanning unit and a scanning platform;
a paper tray assembly, comprising an input paper tray and an output paper tray; and
a paper delivery path, disposed below the upper scan module, the scanning platform being positioned between the scanning unit and the paper delivery path, and the paper delivery path comprising:
a scanning passage, disposed below the scanning unit;
a paper feeding passage, one end thereof connected to the scanning passage, and another end thereof disposed corresponding to the input paper tray;
a paper output passage, one end thereof disposed corresponding to the output paper tray;
a reversing passage, one end thereof connected to the scanning passage, and another end thereof connected to the paper output passage;
a returning passage, one end thereof connected to an intersection of the reversing passage and the paper output passage, and another end thereof connected to an intersection of the scanning passage and the paper feeding passage;
a reversing mechanism, disposed between the paper output passage and the output paper tray, and configured to flip and feed the paper to the output paper tray;
a first switching guide mechanism, arranged at an intersection of the reversing passage, the returning passage and the paper output passage, and configured to guide the paper to be transported from the paper output passage to the returning passage; and
a second switching guide mechanism, arranged at an intersection of the paper output passage, the output paper tray and the reversing mechanism, and configured to guide the paper to be transported from the paper output passage to the output paper tray or to be transported from the paper output passage to the reversing mechanism.

5. The automatic document feeder according to claim 4, wherein the scanning unit is configured to move relative to the scanning platform and capture an image of the paper located on the scanning passage or on the scanning platform; the reversing passage is shaped as a C-shaped passage, and the paper feeding passage is arranged above the first paper output passage; the first switching guide mechanism comprises a first swinging block configured to selectively close or open the reversing passage; and the second switching guide mechanism comprises a second swinging block configured to block between the paper output passage and the reversing mechanism, or block between the paper output passage and the output paper tray.

6. The automatic document feeder according to claim 4, wherein the paper output tray comprises a first side and a second side opposite to each other, and the paper output passage is located adjacent to the first side of the paper output tray and feeds the paper from the first side towards the second side; the reversing mechanism comprises a paper feeding portion located adjacent to the second side of the paper output tray and feeding the paper from the second side towards the first side.

7. The automatic document feeder according to claim 6, wherein the reversing mechanism is disposed above the output paper tray, and the reversing mechanism comprises at least one negative pressure roller and a breathable belt adapted to sheathe the at least one negative pressure roller and configured to rotate with the at least one negative pressure roller, wherein the paper feeding portion is structured by an arc-shaped outer surface and the breathable belt; the arc-shaped outer surface is located adjacent to the second side of the at least one negative pressure roller and rotatable along a direction from the second side towards the first side, and the breathable belt covers an outside of the arc-shaped outer surface.

8. The automatic document feeder according to claim 4, wherein the paper delivery path further comprises a feeding roller assembly, and the feeding roller assembly comprises a bidirectional feeding roller installed on the first paper output passage, a first one-way paper feeding roller and a pickup roller respectively installed on the paper feeding passage, and a second one-way paper feeding roller installed on the scanning passage.

9. An automatic document feeder, used for transporting a paper, comprising:
an upper scan module, comprising a scanning unit and a scanning platform;
a paper tray assembly, comprising an input paper tray and an output paper tray; and
a paper delivery path, disposed below the upper scan module, the scanning platform being positioned between the scanning unit and the paper delivery path, and the paper delivery path comprising:
a scanning passage, disposed below the scanning unit;
a paper feeding passage, one end thereof connected to the scanning passage, and another end thereof disposed corresponding to the input paper tray;
a paper output passage, one end thereof disposed corresponding to the output paper tray;
a reversing passage, one end thereof connected to the scanning passage, and another end thereof connected to the paper output passage;
a returning passage, one end thereof connected to an intersection of the reversing passage and the paper output passage, and another end thereof connected to an intersection of the scanning passage and the paper feeding passage;
a reversing mechanism, arranged between the paper output passage and the output paper tray, and configured to flip and feed the paper to the output paper tray; and
a switching guide mechanism, arranged at an intersection of the paper output passage, the output paper tray and the reversing mechanism, and configured to guide the paper to be transported from the paper output passage to the output paper tray or to be transported from the paper output passage to the reversing mechanism.

10. The automatic document feeder according to claim 9, wherein the scanning unit is configured to move relative to the scanning platform and capture an image of the paper located on the scanning passage or on the scanning platform; the reversing passage is shaped as a C-shaped passage, and the paper feeding passage is arranged below the paper output passage; the returning passage is disposed below the scanning passage; the switching guide mechanism comprises a swinging block blocking a portion between the paper output passage and the reversing mechanism, or blocking another portion between the paper output passage and the output paper tray.

11. The automatic document feeder according to claim 9, wherein the paper output tray comprises a first side and a second side opposite to each other, and the paper output passage is located adjacent to the first side of the paper output tray and feeds the paper from the first side towards the second side; the reversing mechanism comprises a paper feeding portion located adjacent to the second side of the paper output tray and feeding the paper from the second side towards the first side.

12. The automatic document feeder according to claim 11, wherein the reversing mechanism is disposed above the output paper tray, and the reversing mechanism comprises at least one negative pressure roller and a breathable belt adapted to sheathe the at least one negative pressure roller and configured to rotate with the at least one negative pressure roller, wherein the paper feeding portion is structured by an arc-shaped outer surface and the breathable belt; the arc-shaped outer surface is located adjacent to the second side of the at least one negative pressure roller and rotatable along a direction from the second side towards the first side, and the breathable belt covers an outside of the arc-shaped outer surface.

13. The automatic document feeder according to claim 9, wherein the paper delivery path further comprises a feeding roller assembly, and the feeding roller assembly comprises a bidirectional feeding roller installed on the first paper output passage, a first one-way paper feeding roller and a pickup roller respectively installed on the paper feeding passage, and a second one-way paper feeding roller installed on the scanning passage or the reversing passage.

14. An automatic document feeder, used for transporting a paper, comprising:
an upper scan module, comprising a scanning unit and a scanning platform;
a paper tray assembly, comprising an input paper tray and an output paper tray; and
a paper delivery path, disposed below the upper scan module, wherein the scanning platform is positioned between the scanning unit and the paper delivery path, and the paper delivery path comprising:
a scanning passage, disposed below the scanning unit;
a paper feeding passage, one end thereof connected to the scanning passage, and another end thereof disposed corresponding to the input paper tray;
a paper output passage, one end thereof connected to the scanning passage, and another end thereof disposed corresponding to the output paper tray;
a reversing passage, one end thereof connected to an intersection of the scanning passage and the paper feeding passage, and another end thereof connected to an intersection of the scanning passage and the paper output passage;
a reversing mechanism, arranged between the paper output passage and the output paper tray, and configured to flip and feed the paper to the output paper tray; and
a switching guide mechanism, arranged at an intersection of the paper output passage, the output paper tray and the reversing mechanism, and configured to guide the paper to be transported from the paper output passage to the output paper tray or to be transported from the paper output passage to the reversing mechanism.

15. The automatic document feeder according to claim 14, wherein the scanning unit is configured to move relative to the scanning platform and capture an image of the paper located on the scanning passage or on the scanning platform; the reversing passage is shaped as a C-shaped passage, and the paper feeding passage and the paper output passage are respectively arranged on two sides of the reversing passage; the reversing passage is disposed below the scanning passage; the switching guide mechanism comprises a swinging block blocking a portion between the paper output passage and the reversing mechanism or blocking another portion between the paper output passage and the output paper tray; the paper delivery path further comprises a feeding roller assembly, and the feeding roller assembly comprises a bidirectional feeding roller installed on the paper output passage, a one-way paper feeding roller and a pickup roller respectively installed on the paper feeding passage.

16. The automatic document feeder according to claim 14, wherein the paper output tray comprises a first side and a second side opposite to each other, and the paper output passage is located adjacent to the first side of the paper output tray and feeds the paper from the first side towards the second side; the reversing mechanism comprises a paper feeding portion located adjacent to the second side of the paper output tray and feeding the paper from the second side towards the first side.

17. The automatic document feeder according to claim 16, wherein the reversing mechanism is disposed above the output paper tray, and the reversing mechanism comprises at least one negative pressure roller and a breathable belt adapted to sheathe the at least one negative pressure roller and configured to rotate with the at least one negative pressure roller; the paper feeding portion is structured by an arc-shaped outer surface and the breathable belt, and the arc-shaped outer surface is located adjacent to the second side of the at least one negative pressure roller and rotatable along a direction from the second side towards the first side, and the breathable belt covers an outside of the arc-shaped outer surface.

18. An automatic document feeder for transporting a paper, comprising:
an upper scan module, comprising a scanning unit and a scanning platform;
a paper tray assembly, comprising an input paper tray, a first output paper tray, and a second output paper tray; and
a paper delivery path, disposed below the upper scan module, wherein the scanning platform is positioned between the scanning unit and the paper delivery path, and the paper delivery path comprising:
a scanning passage, disposed below the scanning unit;
a paper feeding passage, one end thereof connected to the scanning passage, and another end thereof disposed corresponding to the input paper tray;
a first paper output passage, one end thereof disposed corresponding to the first output paper tray;
a first reversing passage, one end thereof connected to the scanning passage, and another end thereof connected to the first paper output passage;
a second reversing passage, one end thereof connected to an intersection of the scanning passage and the paper feeding passage, and another end thereof connected to the first paper output passage and the first reversing passage;
a second paper output passage, comprising a round-trip passage, a first diversion passage, and a second diversion passage, wherein the round-trip passage is disposed corresponding to the second output paper tray; one end of the first diversion passage is connected to an intersection of the scanning passage and the first reversing passage and another end of the first diversion passage is connected to the round-trip passage; one end of the second diversion passage is connected to an intersection of the first reversing passage and the second reversing passage and another end of the second diversion passage is connected to an intersection of the round-trip passage and the first diversion passage;
a first switching guide mechanism, arranged at an intersection of the scanning passage, the first reversing passage, and the first diversion passage, wherein the first switching guide mechanism is configured to guide the paper to be transported from the scanning passage to the first reversing passage or to be transported from the scanning passage to the first diversion passage; and
a second switching guide mechanism, arranged at an intersection of the first paper output passage, the first reversing passage, the second reversing passage and the second diversion passage, and configured to guide the paper to be transported from the first reversing passage to the first paper output passage, or to be transported from the second diversion passage to the second reversing passage.

19. The automatic document feeder according to claim 18, wherein the scanning unit is configured to move relative to the scanning platform and capture an image of the paper located on the scanning passage or on the scanning platform; the first reversing passage and the second reversing passage are shaped C-shaped passages; an annular passage is structured by the scanning passage, the first reversing passage, and the second reversing passage together; the first switching guide mechanism comprises a first swinging block to close the first reversing passage or the first diversion passage; and the second switching guide mechanism comprises a second swinging block to close the first paper output passage or the second reversing passage; and the second diversion passage is disposed below the first diversion passage.

20. The automatic document feeder according to claim 18, wherein the paper delivery path further comprises a feeding roller assembly, and the feeding roller assembly comprises a bidirectional feeding roller installed on the round-trip passage, a first one-way paper feeding roller and a pickup roller respectively installed on the paper feeding passage, a second one-way paper feeding roller installed on the first paper output passage, a third one-way paper feeding roller installed on the first reversing passage and adjacent to the first paper output passage.
